(19) United States
(12) Patent Application Publication
(10) Pub. No.: US 2011/0097685 A1
(43) Pub. Date: Apr. 28, 2011

(54) Gingival cord tucker for use with dental implants

(76) Inventor: Lon Jude Latiolais, Georgetown, TX (US)

(21) Appl. No.: 12/589,758

(22) Filed: Oct. 28, 2009

(51) Int. Cl. A61C 5/14

(52) U.S. Cl. 433/136

(57) ABSTRACT

A dental apparatus and methods of use for placing a cord beneath a gum line proximate to a dental implant abutment, attachment, or fixture, the dental apparatus including a handle and a cord tucking tool secured to at least one end of the handle. The cord tucking tool is provided with a shape complementary to the radius of the base of the involved portion of a dental implant, such as a concave region or tapered face, such that when the tip of the cord tucking tool contacts a length of the cord, contact between the cord tucking tool and the dental implant is minimized.

### FIELD

The present invention relates, generally, to a dental apparatus usable to place a gingival retraction cord, or similar objects, beneath a gum line proximate to a dental implant, implant abutment, attachment, or fixture.

### BACKGROUND

When performing restorative dental procedures or other dental operations, such as obtaining impressions of a tooth, dental implant, or other restorative dental feature, it is often necessary to retract gingival tissue from the area immediately adjacent to the tooth or other dental feature. Otherwise, gingival tissue, saliva, and/or gingival bleeding can hinder access to necessary portions of the tooth or other dental feature that are located beneath the gum line. Typically, when retracting gingival tissue surrounding a tooth, a gingival retraction cord is used to temporarily separate portions of the gum from the tooth. In use, the gingival cord is looped closely around a tooth, and must then be packed around the base of the tooth to forcibly push the adjacent gingival tissue away from the tooth.

Conventionally, this cord-packing procedure is performed using a narrow metallic dental instrument with a blunted tip to forcefully push the cord between the tooth and gum tissue, compressing the cord to cause formation of a temporary gap between the tooth and surrounding gum tissue. Packing a gingival cord in this manner can be a time-intensive process, can cause discomfort to a patient, and can cause trauma and damage to the tooth and/or the gum.

Though it is often desirable to obtain an impression of a region of the gum line proximate to a dental implant, conventional metallic cord-packing apparatuses are not usable to retract gingival tissue from an implant abutment due to the fact that contact between a metallic instrument and a titanium abutment can scratch or otherwise damage one or both metal objects. This is a very significant concern, as a scratch on the surface of a dental implant abutment, attachment, or fixture proximate to the gum line can allow the accumulation of bacteria within the scratch, which can proliferate into adjacent gum tissue and jawbone, both of which have been cut and/or drilled to accommodate the implant. Adjacent teeth can also be affected. Bacterial infection within the bone normally requires removal of the affected regions of the bone, bone replacement through extensive grafting and other surgery, reconstruction of affected gum tissue, and replacement of the dental implant. Often the affected region of the oral cavity cannot withstand the entirety of these procedures, and permanent damage and/or disfigurement results. As such, conventional metallic dental instruments are not used proximate to dental implant abutments, attachments, fixtures, and other metallic dental features.

Additionally, contact between a conventional cord-packing instrument and an implant abutment can cause discomfort to a patient. Furthermore, the generally round cross-sectional shape of an implant abutment causes use of conventional dental instruments directly adjacent to the implant abutment to be difficult when it is desirable to minimize contact between the instrument and the implant abutment.

A need exists for a dental apparatus usable to place a cord around a dental implant abutment, attachment, or fixture without causing damage to the implant or to the apparatus, and without causing discomfort to a patient.

A further need exists for a dental apparatus usable to place a cord around a dental implant abutment, attachment, or fixture while minimizing contact between the apparatus and the implant.

A need also exists for a dental apparatus having an operative area sized to enable efficient and rapid tucking of a gingival retraction cord, without requiring time-intensive cord-packing methods.

The present invention meets these needs.

### SUMMARY

The present invention relates, generally, to a dental apparatus usable to place a cord beneath a gum line proximate to a dental implant abutment, attachment, or fixture. Such a procedure is useful when it is desired to temporarily retract gingival tissue surrounding an implant abutment, attachment, or fixture, such as when obtaining an impression of an implant abutment and/or surrounding teeth for purposes of later shaping the implant abutment and corresponding temporary and permanent crowns.

The apparatus can include an elongate handle having a cord tucking tool secured to one or both ends. The cord tucking tool includes a concave region having a radius of curvature relative to the axis of the handle. The concave region provides the cord tucking tool with an arcuate tip. The radius of curvature of the concave portion of the cord tucking tool can be sized relative to the base of the a dental implant abutment, attachment, or fixture such that when the cord tucking tool is placed adjacent to the dental implant abutment, attachment, or fixture, contact between the apparatus and the implant is minimized. The arcuate tip is thereby usable to contact a length of cord, enabling the cord to be tucked between the base of the dental implant abutment, attachment, or fixture and the surrounding gingival tissue using a minimum number of strokes due to the width of the tip, while the curvature of the tip enables tucking of the cord without contacting the implant. In comparison, a conventional cord-packing tool contacts a single point along a cord, requiring numerous strokes to pack the entire length of a cord around a tooth. In a preferred embodiment of the invention, the cord tucking tool can be formed from a non-metallic material, such as plastic, to prevent damage to any portion of a dental implant through any incidental contact between the cord tucking tool and the implant, which can prevent the possibility of catastrophic infection, as described previously. Use of a non-metallic material, such as plastic, also minimizes production costs, facilitating disposal, replacement, and interchangeability of cord tucking tools.

The cord tucking tool can be provided with a variety of dimensions and shapes, depending on the diameter and shape of the dental implant abutment, attachment, or fixture around which a cord is to be tucked, the region of the oral cavity to be accessed, the position of adjacent teeth, and other similar factors. In various embodiments of the invention, the cord tucking tool can include an arrowhead shape, a shoveled shape having a semicircular cross section, or a dimpled shape having an hourglass cross section. The cord tucking tool can further include an angled shank disposed between the handle and the arcuate tip, the shank having one or more angles adapted to facilitate access of the cord tucking tool to a selected region of the gum line.

In further embodiments of the invention, the dental apparatus can be provided with two cord tucking tools, one cord tucking tool secured to each end of the handle. The cord tucking tools can each be provided with differing radii of curvature and/or differently sized arcuate tips for enabling a single dental apparatus to be used to tuck a cord around multiple sizes and/or types of dental implant abutments, attachments, or fixtures. Alternatively or additionally, each cord tucking tool can be rotationally disposed from one another, such as in a perpendicular relationship, enabling each cord tucking tool to be used to efficiently access differing portions of the oral cavity and/or differing sides of a dental implant abutment, attachment, or fixture. In an embodiment of the invention, one or more cord tucking tools can be removably attachable to the handle, such as through use of threaded connections, enabling interchangeability of dental implements when it is desirable to utilize cord tucking tools having differing dimensions, shapes, or angles.

The present invention thereby provides for apparatuses and methods for placing cord around a dental implant abutment, attachment, or fixture without causing damage to the apparatus or implant, and without causing discomfort to a patient, while minimizing contact between the apparatus and any portion of the implant. Further, the present invention provides apparatuses and methods able to more efficiently and rapidly tuck a gingival retraction cord when compared to conventional, time-intensive cord-packing apparatuses and methods.

### BRIEF DESCRIPTION OF THE DRAWINGS

In the detailed description of various embodiments of the present invention presented below, reference is made to the accompanying drawings, in which:

FIG. 1 depicts a perspective view of an embodiment of a cord tucking tool usable with the present invention.

FIG. 2 depicts the cord tucking tool of FIG. 1 disposed in association with a gingival retraction cord and a dental implant abutment.

FIG. 3 depicts an embodiment of a dental apparatus that includes the cord tucking tool of FIG. 1 secured to a handle.

FIG. 4 depicts a perspective view of an embodiment of a cord tucking tool usable with the present invention.

FIG. 5 depicts the cord tucking tool of FIG. 4 disposed in association with a gingival retraction cord and a dental implant abutment.

FIG. 6 depicts an embodiment of a dental apparatus that includes the cord tucking tool of FIG. 4 secured to a handle.

FIG. 7 depicts a perspective view of an embodiment of a cord tucking tool usable with the present invention.

FIG. 8 depicts the cord tucking tool of FIG. 7 disposed in association with a gingival retraction cord and a dental implant abutment.

FIG. 9 depicts an embodiment of a dental apparatus that includes the cord tucking tool of FIG. 7 secured to a handle.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

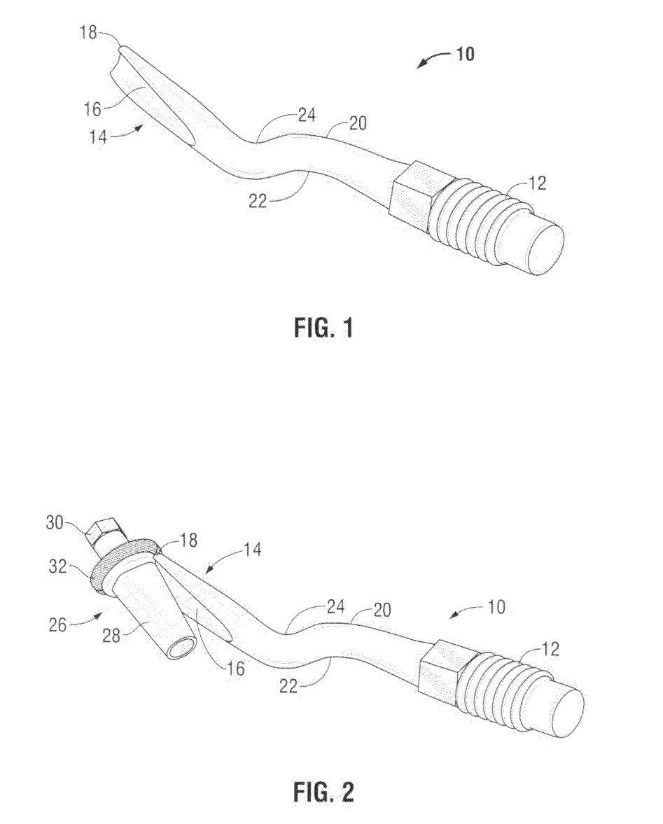

Referring now to FIG. 1, an embodiment of a cord tucking tool (10) is depicted.

The depicted embodiment of the cord tucking tool (10) is shown having an attachment region (12), which includes exterior threads for engagement with complementary interior threads within an end of a handle. It should be understood that while FIG. 1 depicts an attachment region (12) having threads, other types of engagement between the cord tucking tool (10) and a handle are also usable, including, without limitation, snap-fitting, force-fitting, adhesives, fasteners, or other similar types of engagement. In an embodiment of the invention, the cord tucking tool (10) and a handle could be integrally formed as a single piece.

A head region (14) is shown disposed opposite the attachment region (12), the head region (14) being shown having a generally shovel-like shape with a semicircular cross section. The depicted head region (14) includes a concave portion (16), which defines an arcuate tip (18) at the distal end of the cord tucking tool (10). The concave portion (16) of the head region (14) can be provided with a radius of curvature and taper angle complementary to that of a dental implant abutment, attachment, or fixture, such that when the cord tucking tool (10) is placed adjacent to a dental implant, the implant abutment, attachment, or fixture is partially encircled by the head region (14). The arcuate tip (18) is then usable to contact and tuck a gingival retraction cord between the dental implant abutment, attachment, or fixture and the surrounding gingival tissue while contact between the cord tucking tool (10) and the implant is minimized. While the dimensions of the cord tucking tool can vary, depending on the type, size, and shape of the dental implant feature about which a cord is to be placed, in an exemplary embodiment of the invention, the head region (14) can have a length ranging from 7.188 to 8.77 millimeters, and the concave region (16) can have a radius of curvature ranging from 2.098 to 2.899 millimeters, providing the arcuate tip (18) with an arc length ranging from 2.307 to 2.832 millimeters. Dimensions of the cord tucking tool can further vary depending on the material from which the cord tucking tool is formed, as more durable materials can possess thinner dimensions than less durable materials without risk of breakage during use.

An angled shank (20) is shown disposed between the attachment region (12) and the head region (14), the angled shank (20) being shaped to facilitate access of the concave region (16) and arcuate tip (18) to selected portions of an oral cavity. While the angled shank (20) can have any desired shape, including a generally straight shape, or any number of acute or obtuse angles, FIG. 1 depicts the angled shank (20) having a first angle (22) proximate to the attachment member (12), and a second angle (24) proximate to the head region (14), both of which are depicted as obtuse angles.

In an embodiment of the invention, the entirety of the cord tucking tool (10) can be formed from any generally rigid, non-metallic material, such as plastic, to avoid scratching or otherwise causing damage to dental implants or other metallic fixtures in an oral cavity.

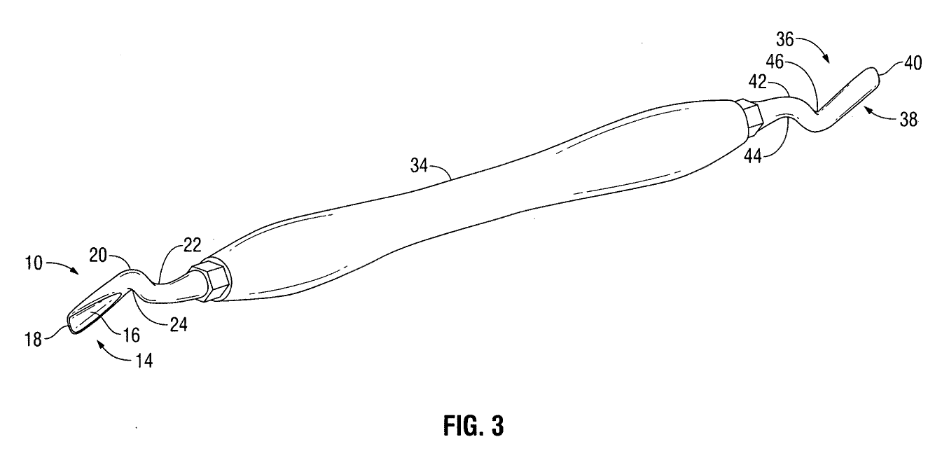

Referring now to FIG. 2, the cord tucking tool (10) of FIG. 1 is depicted, having the attachment region (12), head region (14), and angled shank (20), as described previously. The cord tucking tool (10) is shown in operative engagement proximate to a dental implant (26). The dental implant (26) can include any type of implant or implant system known in the art, including any manner of abutment, attachment, or fixture, most implants typically being formed from titanium or a similar metal, including a first portion implanted beneath the gum line through a threaded engagement or similar type of engagement with the jawbone, and a second portion extending above the gum line that is threadably or otherwise engaged with the first portion. FIG. 2 depicts the dental implant (26) including an implant abutment (28) secured to a lower portion (30). Though FIG. 2 depicts both portions of the dental implant (26) external from an oral cavity, it should be understood that the lower portion (30) is normally placed within gum tissue, while the implant abutment (28) extends from the gum to receive a crown. The implant abutment (28) is shown having a generally cylindrical base and a generally frustro-conical body disposed above the base. The round shape of the base generally hinders the use of conventional cord-packing apparatuses and methods.

A gingival retraction cord (32) is shown disposed around the implant abutment (28), with the cord tucking tool (10) in engagement therewith. The radius of curvature of the concave region (16) is sized such that the arcuate tip (18) can engage the gingival retraction cord (32) while contact between the implant abutment (28) and the head region (14) is minimized. Additionally, the width of the arcuate tip (18) enables a significant length of the gingival retraction cord (32) to be tucked between the dental implant (26) and surrounding gingival tissue with a minimum of strokes. By comparison, a conventional cord-packing instrument contacts only a single point along a gingival retraction cord, requiring more time-intensive methods to forcefully pack a cord beneath a gum line. Furthermore, conventional cord-packing instruments are not suitable for use proximate to dental implant abutments, attachments, or fixtures due to the difficulty inherent in packing a cord around portions of a dental implant without contacting the implant.

Referring now to FIG. 3, an embodiment of a dental apparatus is shown, the dental apparatus including the cord tucking tool (10) of FIGS. 1 and 2, and a second cord tucking tool (36) secured to a handle (34). The depicted handle (34) includes attachment regions at each end, which can include, without limitation, complementary threads for engaging the attachment regions (not visible in FIG. 3) of each cord tucking tool (10, 36). Other methods of engagement between the cord tucking tools (10, 36) and the handle (34) are also usable, as described previously. The handle can be made of any generally rigid, durable material including, without limitation, surgical steel, plastic, composite, one or more polymers, or combinations thereof. The handle can have any length and diameter sized for manipulation by hand and passage into and from an oral cavity, and can include one or more regions having varying thickness, knurling, or other materials known in the art to facilitate grip and manual manipulation.

The first cord tucking tool (10) includes the head region (14), angled shank (20), and attachment region (not visible in FIG. 3), as described previously. The second cord tucking tool (36) similarly includes an attachment region (not visible in FIG. 3), a head region (38), and an angled shank (42). The second head region (38) is shown having a generally shovel-like shape, similar to that of the first head region (14), the second head region (38) having a concave region (not visible in FIG. 3) with a radius of curvature defining an arcuate tip (40). The second head region (38) is shown rotationally disposed approximately 180 degrees from the first head region (14), such that opposing ends the depicted dental apparatus are usable to access differing regions of an oral cavity and/or different sides of a dental implant. Similarly, the second angled shank (42) is shown having first and second angles (44, 46), equal and opposite to the angles (22, 24) of the first angled shank (20) to enable the second cord tucking tool (38) to more efficiently access differing areas along a gum line.

It should be understood that while FIG. 3 depicts the first cord tucking tool (10) rotatably disposed approximately 180 degrees from the second cord tucking tool (36), any rotational orientation between the cord tucking tools (10, 36) is usable. Further, it should be understood that the first and second angled shanks (20, 42) can have differing angles to enable access to different portions of the oral cavity. Additionally, the radii of curvature of the concave portions of each cord tucking tool (10, 36) can differ such that each cord tucking tool (10, 36) can be adapted for use with dental implants having differing shapes or sizes. In an embodiment of the invention, each cord tucking tool (10, 36) can be removable and interchangeable, enabling the depicted apparatus to be readily adapted for use with any type of dental implant at any location within the oral cavity.

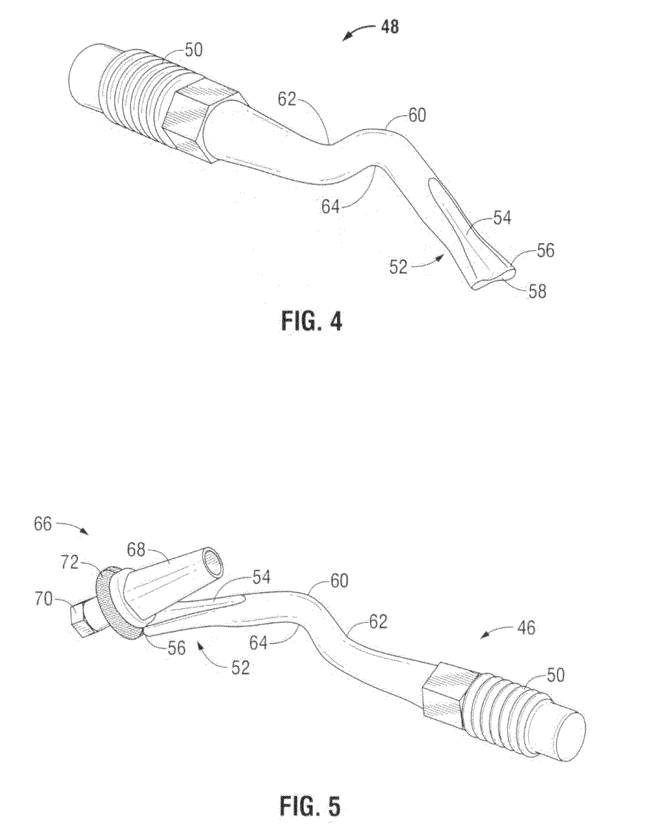

Referring now to FIG. 4, an alternate embodiment of a cord tucking tool (48) is depicted. The cord tucking tool (48) is shown having an attachment region (50), which includes exterior threads for engagement with complementary interior threads within an end of a handle. It should be understood that while FIG. 4 depicts an attachment region (50) having threads, other types of engagement between the cord tucking tool (48) and a handle are also usable, including, without limitation, snap-fitting, force-fitting, adhesives, fasteners, or other similar types of engagement. In an embodiment of the invention, the cord tucking tool (48) and a handle could be integrally formed as a single piece.

A head region (52) is shown disposed opposite the attachment region (50), the head region (52) being shown having a generally dimpled shape with an hourglass cross section. The depicted head region (52) is provided with its shape and cross section due to its inclusion of a first concave portion (54) and a second concave portion (not visible in FIG. 4) disposed on the opposing side of the head region (52) from the first concave portion (54). Each concave portion can be provided with a radius of curvature and taper angle complementary to that of a dental implant abutment, attachment, or fixture, such that when the cord tucking tool (48) is placed adjacent to a dental implant, the implant abutment, attachment, or fixture is partially encircled by the side of the head region (52) immediately adjacent to the implant. The first concave portion (54) defines a first arcuate tip (56) at the distal end of the cord tucking tool (48), while the second concave portion (not visible in FIG. 4) defines a second arcuate tip (58). Either arcuate tip (56, 58) is usable to contact and tuck a gingival retraction cord between a dental implant abutment, attachment, or fixture and the surrounding gingival tissue while contact between the cord tucking tool (48) and the implant is minimized due to the radius of curvature of the corresponding concave portion.

While FIG. 4 depicts a head region (52) having two generally identical concave portions (54) and arcuate tips (56, 58), in an embodiment of the invention, the head region (52) can be provided with two concave portions having differing radii of curvature, such that differing sides of the head region (52) are usable to place a gingival retraction cord adjacent to dental implant abutments, attachments, or fixtures of differing shapes, types, and/or sizes. Additionally, while the dimensions of the cord tucking tool can vary, depending on the type, size, and shape of the dental implant portion about which a cord is to be placed and the material from which the cord tucking tool is formed, in an exemplary embodiment of the invention, the depicted head region (52) can have a length ranging from 7.156 to 7.588 millimeters, and the concave regions (54) can have radii of curvature ranging from 2.230 to 2.472 millimeters, providing the arcuate tips (56, 58) with arc lengths ranging from 1.578 to 2.688 millimeters.

An angled shank (60) is shown disposed between the attachment region (50) and the head region (52), the angled shank (60) being shaped to facilitate access of the head region (52) to selected portions of an oral cavity. While the angled shank (60) can have any desired shape, including a generally straight shape, or any number of acute or obtuse angles, FIG. 4 depicts the angled shank (60) having a first angle (62) proximate to the attachment member (50), and a second angle (64) proximate to the head region (52), both of which are depicted as obtuse angles.

In an embodiment of the invention, the entirety of the depicted cord tucking tool (48) can be formed from any generally rigid, non-metallic material, such as plastic, to avoid scratching or otherwise causing damage to dental implant abutments, attachments, fixtures, or other metallic elements in an oral cavity.

Referring now to FIG. 5, the cord tucking tool (48) of FIG. 4 is depicted, having the attachment region (50), head region (52), and angled shank (60), as described previously. The cord tucking tool (48) is shown in operative engagement proximate to a dental implant (66). The dental implant (66) can include any type of implant or implant system known in the art, including any manner of implant abutment, attachment, or fixture, as described previously. The depicted dental implant (66) is shown having an implant abutment (68) secured to a lower portion (70).

A gingival retraction cord (72) is shown disposed around the implant abutment (68), with the cord tucking tool (48) in engagement therewith. The radius of curvature of the first concave region (54) is sized such that the first arcuate tip (56) can engage the gingival retraction cord (72) while contact between the implant abutment (68) and the head region (52) is minimized. Additionally, the width of the first arcuate tip (56) enables a significant length of the gingival retraction cord (72) to be tucked between the dental implant (66) and surrounding gingival tissue with a minimum of strokes. While FIG. 5 depicts the first arcuate tip (56) and first concave surface (54) in operative engagement with the gingival retraction cord (72) and dental implant (66), it should be understood that the cord tucking tool (48) can be readily inverted such that the second arcuate tip (not visible in FIG. 5) and the second concave portion (not visible in FIG. 5) can be used to place the gingival retraction cord (72) beneath a gum line adjacent to the dental implant (66).

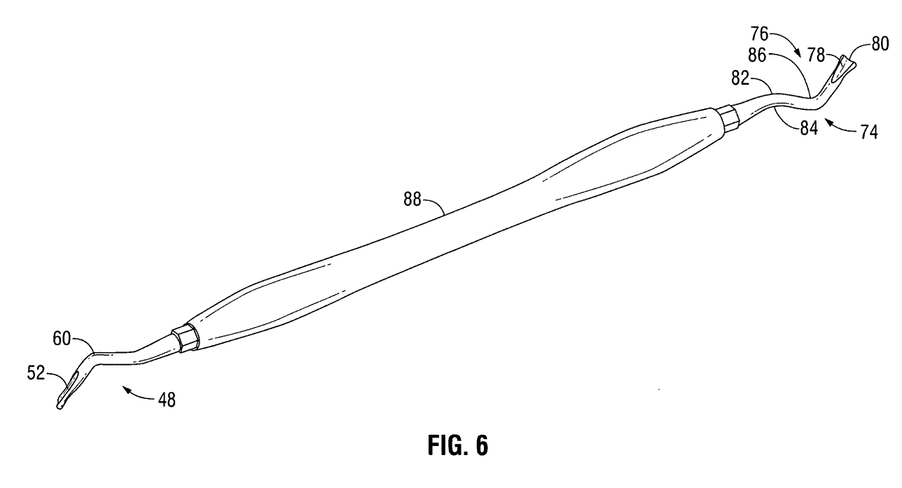

Referring now to FIG. 6, an embodiment of a dental apparatus is shown, the dental apparatus including the cord tucking tool (48) of FIGS. 4 and 5, and a second cord tucking tool (74) secured to a handle (88). The handle (88) can include attachment regions at each end, as described previously, for engagement with each cord tucking tool (48, 74). The first cord tucking tool (48) is shown including the head region (52), angled shank (60), and attachment region (not visible in FIG. 6), described previously. The second cord tucking tool (74) similarly includes an attachment region (not visible in FIG. 6), a head region (76), and an angled shank (82). The second head region (76) is shown having a generally dimpled shape, similar to that of the first head region (52), the second head region (76) having a first concave portion (78) and a second concave portion (not visible in FIG. 6) disposed on the opposing side of the head region (76), each concave portion having a radius of curvature defining an arcuate tip (80). The second head region (76) is shown rotationally disposed approximately 90 degrees from the first head region (52), such that opposing ends of the depicted dental apparatus are usable to access differing regions of an oral cavity and/or different sides of a dental implant abutment, attachment, or fixture. Similarly, the second angled shank (82) is shown having first and second angles (84, 86), equal and opposite to the angles of the first angled shank (60) to enable the second cord tucking tool (76) to more efficiently access differing areas along a gum line.

It should be understood that while FIG. 6 depicts the first cord tucking tool (48) having a head region (52) rotatably disposed approximately 90 degrees from the head region (76) of the second cord tucking tool (74), any rotational orientation between the head regions (52, 76) or cord tucking tools (48, 74) is usable. Further, it should be understood that the first and second angled shanks (60, 82) can have any identical or differing angles, as desired, to enable access to different portions of the oral cavity. Additionally, the radii of curvature of each concave portion of each cord tucking tool (48, 74) can differ such that each cord tucking tool (48, 74) is adapted for use with one or more dental implant abutments, attachments, or fixtures having differing shapes or sizes. Furthermore, in an embodiment of the invention, each cord tucking tool (48, 74) can be removable and interchangeable from the handle (88), enabling the depicted apparatus to be readily adapted for use with any type of dental implant feature at any location within the oral cavity.

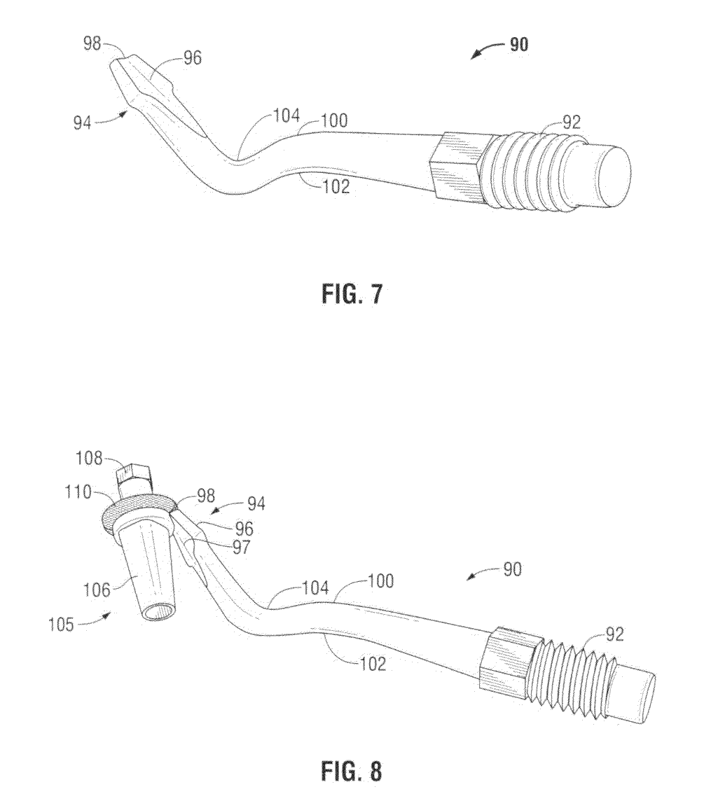

Referring now to FIG. 7, an alternate embodiment of a cord tucking tool (90) is depicted. The cord tucking tool (90) is shown having an attachment region (92), which includes exterior threads for engagement with complementary interior threads within an end of a handle. It should be understood that while FIG. 7 depicts an attachment region (92) having threads, other types of engagement between the cord tucking tool (90) and a handle are also usable, as described above. In an embodiment of the invention, the cord tucking tool (90) and a handle could be integrally formed as a single piece.

A head region (94) is shown disposed opposite the attachment region (92), the head region (94) being shown having an arrowhead-like shape with an elliptical cross section. The head region (94) is provided with its shape and cross section due to its inclusion of a first tapered portion (96) and a second tapered portion (not visible in FIG. 7) disposed on the opposing side of the head region (94) from the first tapered portion (96). Each tapered portion can be provided with a taper angle adapted such that when the cord tucking tool (90) is placed adjacent to a dental implant, contact between the implant abutment, attachment, or fixture and the head region (94) is minimized due to the taper angle of the tapered portion (96). The tapered portions terminate in a tip (98) at the distal end of the cord tucking tool (90). Either side of the tip (98) is usable to contact and tuck a gingival retraction cord between a dental implant abutment, attachment, or fixture and the surrounding gingival tissue while contact between the cord tucking tool (90) and the implant is minimized due to the taper angle of the tapered portions.

While FIG. 7 depicts a head region (94) having two generally identical tapered portions (96), in an embodiment of the invention, the head region (94) can be provided with two tapered portions having differing taper angles, such that differing sides of the head region (94) are usable to place a gingival retraction cord adjacent to dental implant abutments, attachments, or fixtures of differing shapes, types, and/or sizes. Additionally, while the dimensions of the cord tucking tool can vary, depending on the type, size, and shape of the dental implant portion about which a cord is to be placed, in an exemplary embodiment of the invention, the depicted head region (94) can have a length of about 6.805 millimeters, and the tapered portions can have taper angles of approximately 17.915 degrees, providing the elliptical tip (98) with a width of about 1.999 millimeters and a thickness of about 0.492 millimeters. In an embodiment of the invention, the edges of the tip (98) can curve slightly inward to provide an arcuate surface for engaging a gingival retraction cord.

An angled shank (100) is shown disposed between the attachment region (92) and the head region (94) the angled shank (100) being shaped to facilitate access of the head region (94) to selected portions of an oral cavity. While the angled shank (100) can have any desired shape, including a generally straight shape, or any number of acute or obtuse angles, FIG. 7 depicts the angled shank (100) having a first angle (102) proximate to the attachment member (92), and a second angle (104) proximate to the head region (94), both of which are depicted as obtuse angles.

In an embodiment of the invention, the entirety of the depicted cord tucking tool (90) can be formed from any generally rigid, non-metallic material, such as plastic, to avoid scratching or otherwise causing damage to dental implant abutments, attachments, fixtures, or other metallic features in an oral cavity, thereby avoiding the potential for infection and related damage to gum tissue, bone, and surrounding teeth, as described previously.

Referring now to FIG. 8, the cord tucking tool (90) of FIG. 7 is depicted, having the attachment region (92), head region (94), and angled shank (100), as described previously. The head region (94) is shown including the first tapered portion (96) and the second tapered portion (97) disposed on opposing sides of the head region (94). The cord tucking tool (90) is shown in operative engagement proximate to a dental implant (105). The dental implant (105) can include any type of implant or implant system known in the art, and can include any type of abutment, attachment, or fixture, as described above. The depicted dental implant (105) is shown having an implant abutment (106) secured to a lower portion (108).

A gingival retraction cord (110) is shown disposed around the implant abutment (106), with the cord tucking tool (90) in engagement therewith. The taper angle of the second tapered portion (97) extends such that the tip (98) of the cord tucking tool (90) can engage the gingival retraction cord (110) while contact between the implant abutment (106) and the head region (94) is minimized. Additionally, the width of the tip (98) enables a significant length of the gingival retraction cord (110) to be tucked between the dental implant (105) and surrounding gingival tissue with a minimum of strokes. While FIG. 8 depicts the second tapered portion (97) immediately adjacent to the implant abutment (106), it should be understood that the cord tucking tool (90) can be readily inverted such that the first tapered portion (96) is immediately adjacent the implant abutment (106), such as when the placement of the dental implant (105) and/or adjacent teeth would cause a differing angle between the cord tucking tool (90) and the dental implant (105) to be desirable.

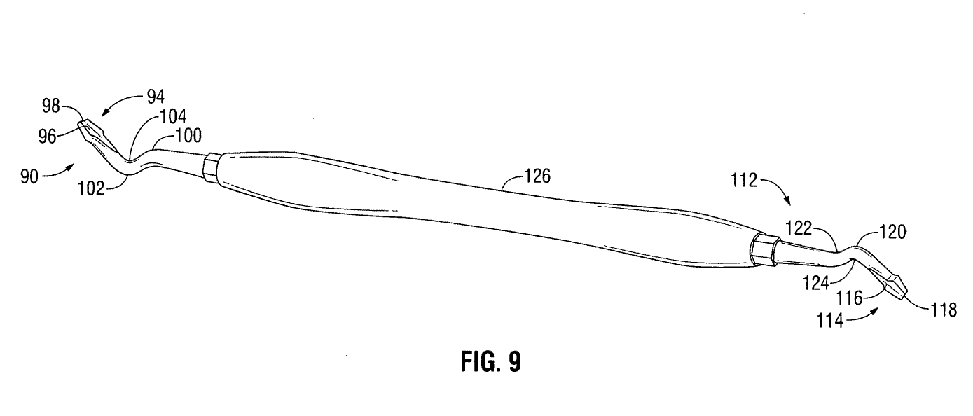

Referring now to FIG. 9, an embodiment of a dental apparatus is shown, the dental apparatus including the cord tucking tool (90) of FIGS. 7 and 8, and a second cord tucking tool (112) secured to a handle (126). The handle (126) can include attachment regions at each end, as described previously, for engagement with each cord tucking tool (90, 112). The first cord tucking tool (90) is shown including the head region (94), angled shank (100), and attachment region (not visible in FIG. 9), as described previously. The second cord tucking tool (112) similarly includes an attachment region (not visible in FIG. 9), a head region (114), and an angled shank (120). The second head region (114) is shown having a generally arrowhead-like shape, similar to that of the first head region (94), the second head region (114) having a tapered portion (116) and a second tapered portion (not visible in FIG. 9) disposed on the opposing side of the second head region (114), each tapered portion having a taper angle adapted to facilitate use of the depicted apparatus adjacent to a dental implant abutment, attachment, or fixture, the tapered portions defining a tip (118) at the distal end of the second cord tucking tool (112). In an embodiment of the invention, the tip (118) can be curved and/or arcuate, similar to the tip (98) of the first cord tucking tool (90), in the manner described above. The second head region (114) is shown rotationally disposed approximately 90 degrees from the first head region (94), such that opposing ends the depicted dental apparatus are usable to access differing regions of an oral cavity and/or different sides of a dental implant abutment, attachment, or fixture. Similarly, the second angled shank (120) is shown having first and second angles (122, 124), equal and opposite to the angles (102, 104) of the first angled shank (100) to enable the second cord tucking tool (112) to more efficiently access differing areas along a gum line.

It should be understood that while FIG. 9 depicts the first cord tucking tool (90) having a head region (94) rotatably disposed approximately 90 degrees from the head region (114) of the second cord tucking tool (112), any rotational orientation between the head regions (94, 114) or cord tucking tools (90, 112) is usable. Further, it should be understood that the first and second angled shanks (100, 120) can have any identical or differing angles, as desired, to enable access to different portions of the oral cavity. Additionally, the taper angles of each tapered portion of each cord tucking tool (90, 112) can differ such that each cord tucking tool (90, 112) is adapted for use with one or more dental implant abutments, attachments, or fixtures having differing shapes or sizes. Furthermore, in an embodiment of the invention, each cord tucking tool (90, 112) can be removable and interchangeable from the handle (126), enabling the depicted apparatus to be readily adapted for use with any type of dental implant at any location within the oral cavity.

In operation a gingival retraction cord can be placed around the base of a dental implant abutment, attachment, or fixture, and a length of the cord can be contacted with the tip of a cord tucking tool. The shape of the cord tucking tool, which can include a concave or tapered region complementary to the radius of the base of the involved portion of the implant, minimizes contact between the cord tucking tool and the implant. The width of the tip enables the tip to contact a length of cord, enabling the cord to be placed beneath the gum line using a minimum number of strokes through pressure applied through the tip.

The present invention thereby provides for apparatuses and methods for placing cord around a dental implant abutment, attachment, or fixture without causing damage to the apparatus or implant, and without causing discomfort to a patient, while minimizing contact between the apparatus and the implant, thereby reducing the potential for infection and related damage to gum tissue, bone, and teeth adjacent to a dental implant. Additionally, through use of the disclosed apparatuses and methods, a gingival retraction cord can be tucked beneath a gum line with greater efficiency when compared to conventional, time-intensive cord-packing apparatuses and methods.

While various embodiments of the present invention have been described with emphasis, it should be understood that within the scope of the appended claims, the present invention might be practiced other than as specifically described herein.

What is claimed is:

1. A dental apparatus for placing a cord beneath a gum line proximate to a dental implant comprising a base, the dental apparatus comprising:
a handle comprising a first end, a second end, and a central axis;
a cord tucking tool secured to the first end, wherein the cord tucking tool comprises a concave region with an arcuate tip, wherein the concave region comprises a radius of curvature relative to the central axis of the handle, and wherein the radius of curvature is sized relative to the base of the dental implant such that the arcuate tip contacts a length of the cord while minimizing contact between the cord tucking tool and the dental implant.

2. The dental apparatus of claim 1, wherein the cord tucking tool comprises a first concave region disposed on a first side defining a first arcuate tip, and a second concave region disposed on a second side defining a second arcuate tip.

3. The dental apparatus of claim 1, wherein the cord tucking tool comprises an arrowhead shape, a shoveled shape with a semicircular cross section, or a dimpled shape with an hourglass cross section.

4. The dental apparatus of claim 1, further comprising a second cord tucking tool secured to the second end, wherein the second cord tucking tool comprises a second concave region with a second arcuate tip, wherein the second concave region comprises a second radius of curvature relative to the central axis of the handle.

5. The dental apparatus of claim 4, wherein the second radius of curvature differs from the radius of curvature of the cord tucking tool secured to the first end for enabling tucking of cord proximate to dental implants having differing sizes.

6. The dental apparatus of claim 4, wherein the second cord tucking tool is disposed perpendicular to the cord tucking tool secured to the first end for facilitating access to differing regions of the gum line.

7. The dental apparatus of claim 1, wherein the cord tucking tool comprises an angled shank disposed between the arcuate tip and the first end of the elongate handle, and wherein the angled shank comprises at least one angle adapted to facilitate access of the cord tucking tool to the gum line.

8. The dental apparatus of claim 1, wherein the cord tucking tool is removably connected to the handle member.

9. The dental apparatus of claim 1, wherein the cord tucking tool is formed from a non-metal for preventing damage to restorative dental features and facilitating disposal.

10. A method for placing a cord beneath a gum line proximate to a dental implant comprising a base with a radius, the method comprising the steps of:
providing a cord about the base of the dental implant;
providing a dental apparatus comprising a first concave region with a first arcuate tip, wherein the first concave region comprises a radius of curvature complementary to the radius of the base;
contacting a length of the cord with the first arcuate tip, wherein the first concave region at least partially encircles the dental implant while minimizing contact between the dental apparatus and the dental implant; and
tucking the length of the cord beneath the gum line using pressure applied to the first arcuate tip.

11. The method of claim 10, wherein the dental apparatus further comprises a second concave region comprising a second arcuate tip perpendicularly disposed in relation to the first concave region, and wherein the method further comprises the steps of contacting the cord with the second arcuate tip while the second concave region at least partially encircles the dental implant while minimizing contact between the dental apparatus and the dental implant and tucking the cord beneath the gum line using pressure applied to the second arcuate tip.

12. An interchangeable dental implement attachable to a handle comprising a central axis for placing cord beneath a gum line proximate to a dental implant comprising a base with a radius, the implement comprising:
an attachment member comprising a first end and a second end, wherein the first end is configured to engage the handle; and
a cord tucking tool disposed at the second end, wherein the cord tucking tool comprises a concave region with an arcuate tip, wherein the concave region comprises a radius of curvature relative to the central axis of the handle, and wherein the radius of curvature is complementary to the radius of the base such that the arcuate tip contacts a length of the cord while minimizing contact between the cord tucking tool and the dental implant.

13. The dental implement of claim 12, wherein the attachment member, the cord tucking tool, or combinations thereof are formed from a non-metal for preventing damage to restorative dental features and facilitating disposal.

14. The dental implement of claim 12, wherein the first end is configured to threadably engage the handle.

15. The dental implement of claim 12, wherein the cord tucking tool comprises a first concave region disposed on a first side defining a first arcuate tip, and a second concave region disposed on a second side defining a second arcuate tip.

16. The dental implement of claim 12, wherein the cord tucking tool comprises an arrowhead shape, a shoveled shape with a semicircular cross section, or a dimpled shape with an hourglass cross section.

17. The dental implement of claim 12, further comprising an angled shank disposed between the arcuate tip and the first end, wherein the angled shank comprises at least one angle adapted to facilitate access of the cord tucking tool to the gum line.

18. A dental apparatus for placing a cord beneath a gum line proximate to a dental implant comprising a base, the dental apparatus comprising:
an elongate handle comprising a first end, a second end, and a central axis;
a cord tucking tool secured to the first end, wherein the cord tucking tool comprises a tapered face with a tip, wherein the tapered face comprises a taper angle relative to the central axis of the handle, and wherein the taper angle extends relative to the base of the dental implant such that the tip contacts a length of the cord while minimizing contact between the cord tucking tool and the dental implant.

19. The dental apparatus of claim 18, wherein the cord tucking tool comprises a first tapered face on a first side and a second tapered face on a second side, and wherein the first tapered face comprises a first taper angle and the second tapered face comprises a second taper angle.

20. The dental apparatus of claim 18, wherein the cord tucking tool comprises an arrowhead shape, a shoveled shape with a semicircular cross section, or a dimpled shape with an hourglass cross section.

21. The dental apparatus of claim 18, further comprising a second cord tucking tool secured to the second end, wherein the second cord tucking tool comprises a second tapered face with a second tip, wherein the second tapered face comprises a second taper angle relative to the central axis of the handle.

22. The dental apparatus of claim 21, wherein the second taper angle differs from taper angle of the cord tucking tool secured to the first end for enabling tucking of cord proximate to dental implants having differing sizes.

23. The dental apparatus of claim 21, wherein the second cord tucking tool is disposed perpendicular to the cord tucking tool secured to the first end for facilitating access to differing regions of the gum line.

24. The dental apparatus of claim 18, wherein the cord tucking tool comprises an angled shank disposed between the tip and the first end of the elongate handle, and wherein the angled shank comprises at least one angle adapted to facilitate access of the cord tucking tool to the gum line.

25. The dental apparatus of claim 18, wherein the cord tucking tool is removably connected to the handle member.

26. The dental apparatus of claim 18, wherein the cord tucking tool is formed from a non-metal for preventing damage to restorative dental features and facilitating disposal.

27. A method for placing a cord beneath a gum line proximate to a dental implant comprising a base with a radius, the method comprising the steps of:
providing a cord about the base of the dental implant;
providing a dental apparatus comprising a first tapered face with a first tip, wherein the first tapered face comprises a first taper angle complementary to the radius of the base;
contacting a length of the cord with the first tip, wherein the first tapered face is disposed adjacent to the dental implant while minimizing contact between the dental apparatus and the dental implant; and
tucking the length of the cord beneath the gum line using pressure applied to the first tip.

28. The method of claim 27, wherein the dental apparatus further comprises a second tapered face comprising a second tip perpendicularly disposed in relation to the first tapered face, and wherein the method further comprises the steps of contacting the cord with the second tip while the second tapered face is disposed adjacent to the dental implant while minimizing contact between the dental apparatus and the dental implant and tucking the cord beneath the gum line using pressure applied to the second tip.

29. An interchangeable dental implement attachable to a handle comprising a central axis for placing cord beneath a gum line proximate to a dental implant comprising a base with a radius, the implement comprising:
an attachment member comprising a first end and a second end, wherein the first end is configured to engage the handle; and
a cord tucking tool disposed at the second end, wherein the cord tucking tool comprises a tapered face with a tip, wherein the tapered face comprises a taper angle relative to the central axis of the handle, and wherein the taper angle is complementary to the radius of the base such that the tip contacts a length of the cord while minimizing contact between the cord tucking tool and the dental implant.

30. The dental implement of claim 29, wherein the attachment member, the cord tucking tool, or combinations thereof are formed from a non-metal for preventing damage to restorative dental features and facilitating disposal.

31. The dental implement of claim 29, wherein the first end is configured to threadably engage the handle.

32. The dental implement of claim 29, wherein the cord tucking tool comprises a first tapered face disposed on a first side defining a first tip, and a second tapered face disposed on a second side defining a second tip.

33. The dental implement of claim 29, wherein the cord tucking tool comprises an arrowhead shape, a shoveled shape with a semicircular cross section, or a dimpled shape with an hourglass cross section.

34. The dental implement of claim 29, further comprising an angled shank disposed between the tip and the first end, wherein the angled shank comprises at least one angle adapted to facilitate access of the cord tucking tool to the gum line.
